(19) United States
(12) Patent Application Publication
(10) Pub. No.: US 2013/0000445 A1
(43) Pub. Date: Jan. 3, 2013

(54) METHOD OF SETTING A SLAG CONSISTENCY AND APPARATUS FOR CARRYING OUT THE METHOD

(76) Inventor: Thomas Matschullat, Eckental (DE)

(21) Appl. No.: 13/583,926

(22) PCT Filed: Feb. 7, 2011
(86) PCT No.: PCT/EP2011/051746

§ 371 Date: Sep. 10, 2012

(30) Foreign Application Priority Data
Mar. 9, 2010 (EP) 1015587.2

(51) Int. Cl. C21C 5/54; C22B 4/08; F27D 19/00

(52) U.S. Cl. 75/10.12; 266/80

(57) ABSTRACT

In a method and an apparatus for setting a slag consistency in an electric arc furnace, structure-borne sound measurements are carried out on the electric arc furnace during the melting

### CROSS-REFERENCE TO RELATED APPLICATIONS

This application is a U.S. National Stage Application of International Application No. PCT/EP2011/051746 filed Feb. 7, 2011, which designates the United States of America, and claims priority to EP Patent Application No. 10155887.2 filed Mar. 9, 2010. The contents of which are hereby incorporated by reference in their entirety.

### TECHNICAL FIELD

The invention relates to a method for setting a slag consistency in an electric arc furnace and to an apparatus for carrying out the method.

### BACKGROUND

In metal production by means of an electric arc furnace, mainly scrap is processed, the precise chemical composition of which is largely unknown. In general, silicon, silicon dioxide, iron oxides and other constituents are present in the scrap which combine to form a nonmetallic by-product known as slag when the scrap is melted down. Because of the unknown chemical composition of the scrap used, it is impossible to predict the chemical composition of the slag which collects on the surface of the molten metal bath formed in the electric arc furnace.

The slag as it forms is foamed by adding carbon and oxygen in order to blanket the arc and increase the energy input to the electric arc furnace. In addition, the foamed slag, also known as foam slag, protects the graphite electrodes, the refractory lining of the furnace vessel as well as water-cooled wall elements of the electric arc furnace from thermal damage and oxidation.

If large amounts of silicon dioxide are present in the slag that has formed, the slag is readily foamable and has reduced surface tension and increased viscosity, but the reducibility of iron(II) oxide in the slag is greatly diminished and large amounts of iron remain unused in the slag. On this point, see FIG. 1 which shows a typical slag system (CaO+MgO+MnO)—FeO—(SiO₂+P₂O₅+Al₂O₃) at a temperature of 1650° C. The region I in FIG. 1 indicates the chemical compositions of readily foamable, but poorly reducible slags in the slag system.

If large amounts of iron(II) oxide are contained in the slag, the slag is readily reducible, but is only poorly foamable, has increased surface tension and lower viscosity. This makes it difficult to blanket the arc, resulting in high energy losses and furnace operating problems. On this point, see the region III in FIG. 1 which indicates the chemical compositions of poorly foamable, but readily reducible slags in the slag system.

At a temperature T, the chemical composition of the slag is therefore directly related to the slag consistency which directly affects the foamability thereof. In the slag system according to FIG. 1, at 1650° C. slags with chemical compositions in the region II have optimum foamability and simultaneous reducibility. This region is also termed the region of technical lime saturation or more precisely dicalcium silicate saturation.

In order to achieve a chemical composition of the slag in the lime saturation region, fixed quantities of additives, in particular burnt lime or dolomitic lime, have hitherto been introduced into the electric arc furnace together with the scrap or via dosing or injection equipment during the ongoing melting process. As the costs of such additives are appreciable, normally as small amounts as possible are used by the operator of an electric arc furnace, which means that the lime saturation region is mostly not achieved, or not straight away, and so the effectiveness of the melting process is reduced.

The target here is a satisfactory metallurgy in the furnace and good foamability of the slag under reducing conditions.

U.S. Pat. No. 6,544,314 B2 describes a method and an apparatus for automatically monitoring and dynamically controlling foam slag formation, particularly for steel production. At least one signal is determined and evaluated which is based on variables which indicate the nature or quality of the slag. The at least one signal is determined here on the basis of the stability of the arc furnace, the viscosity of the foam slag or the temperature obtaining. The addition of additives, in particular oxygen, carbon, magnesium oxide, calcium oxide or calcium carbonate, is performed manually or automatically depending on the evaluation of the at least one signal.

Published unexamined German patent application No. 27 30 600 describes a method for controlling steel refining, wherein lime and flux are added to the melt until lime saturation is achieved in the CaO—FeO—SiO₂ system at the prevailing molten bath temperature.

EP 692 544 A1 discloses a method for controlling foam slag formation in a three-phase AC arc furnace. Carbon is added such that the arc is covered by foam slag. Automatic detection of furnace noise emission is carried on the electric arc furnace and the carbon throughput rate is adjusted as a function of the noise level.

DE 10 2005 034 409 B3 describes a method for determining at least one state variable of an electric arc furnace having at least one electrode, wherein the energy supply to the electric arc furnace is determined using at least one electrical sensor. Vibrations on the electric arc furnace are measured and the at least one state variable of the electric arc furnace is determined using a transfer function which is obtained by evaluating the measured vibrations and by evaluating measurement data from the at least one sensor. Here the height of the foam slag can be determined as the state variable. The method allows automatic open-loop or closed-loop control of the foam slag height.

The electric arc furnace as described in DE 10 2005 034 409 B3 comprises a furnace vessel and at least one electrode, wherein a power supply line is provided for each electrode and wherein, in order to carry out a previously mentioned method in its various embodiments, at least one electrical sensor is provided on a power supply line and at least one structure-borne noise sensor for detecting vibrations is provided on the wall of the furnace vessel. An electrical sensor or a structure-borne noise sensor can be preferably provided for each electrode.

The height of the foam slag is determined using a transfer function of the structure-borne noise in the electric arc furnace. The transfer function characterizes the transmission path of the structure-borne noise from excitation to detection. The structure-borne noise is excited by an injection of power at the electrodes in the arc. The structure-borne noise, i.e. the vibrations caused by the excitation, is transmitted to the wall of the electric arc furnace by the molten steel bath and/or by the foam slag at least partially covering the molten bath. Structure-borne noise may additionally be transmitted at least partially by not yet melted charging material in the electric arc furnace. The structure-borne noise is detected by structure-borne noise sensors which are disposed on the wall of the furnace vessel of the electric arc furnace. The structure-borne noise sensors pick up vibrations on the walls of the furnace vessel. For the precise evaluation of the signals, reference is made to DE 10 2005 034 409 B3.

### SUMMARY

According to various embodiments, an improved method for setting a slag consistency during a melting process in an electric arc furnace and an apparatus for carrying out the method can be provided.

According to an embodiment, a method for setting a slag consistency in an electric arc furnace, may comprise the following steps:—performing structure-borne noise measurements on the electric arc furnace;—determining a behavior over time of a formed quantity of foam slag on the basis of the structure-borne noise measurements;—assigning the determined behavior over time of the foam slag to a first chemical composition of the foam slag that brings about a current consistency of the foam slag;—performing a comparison of the first chemical composition with a number of second chemical compositions for the foam slag that produce an optimum consistency for the foam slag, and, if the current consistency is at variance with the optimum consistency—converting the foam slag from the first chemical composition into one of the second chemical compositions by introducing at least one additive to the foam slag, thereby setting the optimum consistency.

According to a further embodiment, the behavior over time of a formed quantity of foam slag may produce a curve, the slope of which is determined in at least one time interval and assigned to a first chemical composition of the foam slag. According to a further embodiment, a temperature T of the foam slag present during the structure-borne noise measurements can be determined and the determined behavior over time and the temperature T of the foam slag can be assigned to a first chemical composition of the foam slag that brings about the current consistency of the foam slag at the temperature T. According to a further embodiment, the first chemical composition can be compared with a number of second chemical compositions for the foam slag which produce an optimized consistency for the foam slag at the temperature T. According to a further embodiment, to convert the first chemical composition into one of the second chemical compositions, the quantity of the at least one additive required for that purpose can be automatically introduced to the foam slag. According to a further embodiment, the first chemical composition can be converted into one of the second chemical compositions which is achievable at the least cost for the at least one additive required for that purpose. According to a further embodiment, divalent metal ions can be introduced to the foam slag via the at least one additive. According to a further embodiment, the at least one additive can be selected from the group of materials comprising burnt lime, slaked lime, limestone, magnesium oxide, dolomitic lime and iron(II) oxide. According to a further embodiment, the at least one additive can be introduced in a quantity producing lime saturation. According to a further embodiment, the behavior over time of the formed quantity of foam slag based on the structure-borne noise measurements can be determined during refining during which carbon and/or oxygen are injected into the electric arc furnace. According to a further embodiment, the temperature T of the foam slag can be determined indirectly or directly by a contactless optical temperature measurement. According to a further embodiment, the determined behavior over time and possibly the temperature T of the foam slag can be assigned to a first chemical composition of the foam slag using a correlation scheme in which variations over time determined in previous melting processes are stored correlated with an associated chemical composition. According to a further embodiment, for a foam slag consisting of a material system (CaO+MgO+MnO)—FeO—(SiO₂+P₂O₅+Al₂O₃), the second chemical compositions can be selected, in particular at a temperature T of 1650° C., referring to the total weight according to the following three conditions: 32-58 wt. % (CaO+MgO+MnO); 17-51 wt. % FeO; 10-30 wt. % (SiO₂+P₂O₅+Al₂O₃).

According to another embodiment, an apparatus for carrying out a method as described above may comprise—at least one sensor for measuring structure-borne noise on the electric arc furnace,—optionally at least one temperature measuring device for indirectly or directly determining the temperature T of the foam slag,—at least one processing unit which is designed to assign the determined behavior over time and optionally the temperature T of the foam slag to a first chemical composition of the foam slag, to compare the first chemical composition with a number of second chemical compositions for the foam slag, and to output at least one open- or closed-loop control signal, and—at least one dosing device controllable in an open- or closed-loop manner by means of the at least one processing unit for introducing at least one additive (11a, 11b, 11c, 11d, 11e) to the foam slag.

### BRIEF DESCRIPTION OF THE DRAWINGS

By way of example, a method and an apparatus according to various embodiments will be explained with reference to FIGS. 1 to 4 in which

FIG. 1 shows an example of a composition of a slag composed of the material system (CaO+MgO+MnO)—FeO— (SiO₂+P₂O₅+Al₂O₃) at a temperature of 1650° C.;

FIG. 2 plots the behavior over time of the structure-borne noise signal Ks after the injection of carbon into the furnace vessel during refining;

FIG. 3 plots the behavior over time of structure-borne noise signals Ks for three different structure-borne noise sensors on the furnace vessel after the injection of carbon during refining; and

FIG. 4 shows a possible apparatus for carrying out the method.

### DETAILED DESCRIPTION

According to various embodiments the method for setting a slag consistency in an electric arc furnace may comprise the following steps:
performing structure-borne noise measurements on the electric arc furnace;
determining, on the basis of the structure-borne noise measurements, a behavior over time of a formed quantity of foam slag;
assigning the determined behavior over time of the foam slag to a first chemical composition of the foam slag that accounts for a current consistency of the foam slag;
comparing the first chemical composition with a number of second chemical compositions for the foam slag that produce an optimum consistency for the slag, and, in the event of a discrepancy between the current and optimum consistency
converting the foam slag from the first chemical composition to one of the second chemical compositions by introducing at least one additive to the foam slag, thereby setting the optimum consistency.

Determining the current chemical composition of the slag is not necessary here. Instead, the method draws upon past experience as to which behavior over time of foam formation is associated with which chemical composition of the slag. In order to create a corresponding database, the behaviors over time of foam formation for slags of different chemical compositions are acquired in advance, a chemical analysis of the respective slag is performed and this is assigned to the behaviors over time acquired. Thus, in the case of a known behavior over time of foam formation which is obtained by structure-borne noise measurement, a comparable behavior over time can be located in the database and the thereto assigned chemical composition of the previously analyzed slag can be assumed with sufficient accuracy to be the current first chemical composition of the slag.

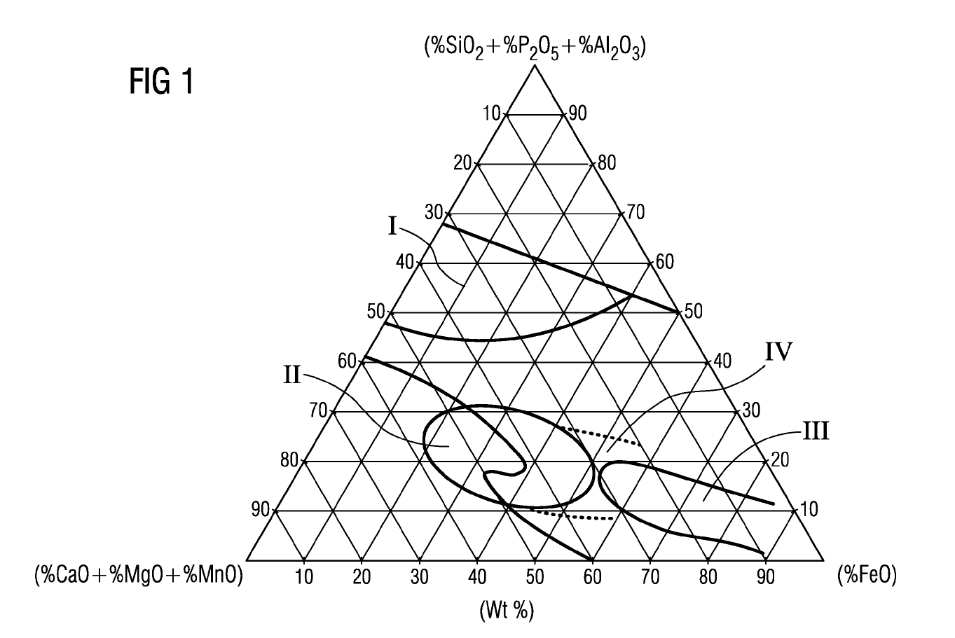

The first chemical composition determined in this way and thus the current consistency of the slag is if necessary modified such that an optimum consistency and therefore good foamability and at the same time good reducibility is provided. Considering FIG. 1, for example, this would mean that if the position of the first chemical composition lies outside region II in the material phase diagram, the first chemical composition is influenced in the direction of a second chemical composition located in region II in order to set the optimum consistency of the slag.

The method according to various embodiments allows more precise dosing of the at least one additive required while at the same time reducing the energy requirement for melting down scrap, thereby minimizing the costs for the at least one additive needed and the energy required. Because of the optimization of the slag consistency, a reduction in iron slagging and therefore an increased production of molten metal, i.e. an increased yield is possible. In addition, good foamability is achieved as a result of optimizing the slag consistency, so that optimum coverage of the refractory material in the furnace vessel and of the electrode material is provided. This results in a reduction in the consumption of refractory and electrode material, as thermal stress and oxidation are reduced. The improved control of the melting process and of the metallurgical properties of the molten bath produced increase the reproducibility of the method and the quality of the metal produced.

The behavior over time of a formed quantity of foam slag produces a curve, wherein the slope thereof can be preferably determined at least in one time interval and, on the basis of empirical values, assigned to a first chemical composition of the foam slag. The magnitude of the slope, which can be positive or negative, directly provides information as to the chemical composition of the slag and is therefore particularly suitable for carrying out the method. However, in addition to the slope, other properties of the curve can also be evaluated, such as the dead time in which no change in the slope is detectable, such as may for example occur after the start of an injection of oxygen into the furnace.

It can be advantageous if a temperature T of the foam slag during the structure-borne noise measurements is determined and the determined behavior over time and the temperature T of the foam slag are assigned to a first chemical composition of the foam slag, which determines the current consistency of the foam slag at the temperature T. The consistency of the slag is dependent not only on the chemical composition of the slag, but also—albeit to a lesser extent—on the temperature thereof. Thus, at a lower temperature T of the slag, fewer second chemical compositions are available than at higher temperatures T, i.e. the region II per FIG. 1 is reduced in size. It must be taken into account here that, as the temperature T of the slag increases, the foamability and viscosity thereof are reduced. If the temperature T of the slag is known, the optimum second chemical compositions at precisely that temperature can be determined, e.g. at 1650° C. as per FIG. 1. If the exact position of the region of lime saturation is known, particularly accurate dosing of the at least one additive required is possible. The more precisely the temperature T is determined, the better the optimum consistency of the slag can be set.

Consequently, the first chemical composition may be preferably compared with a number of second chemical compositions for the foam slag that produce an optimized consistency for the foam slag at the determined temperature T of the slag.

It has been found effective for the conversion of the first chemical composition into one of the second chemical compositions if the quantity of at least one additive required for that purpose is introduced automatically to the foam slag. This minimizes process times and personnel costs. Alternatively, however, this material can also be added manually by operating personnel.

The first chemical composition may be preferably converted into one of the second chemical compositions which can be achieved at minimum cost for the at least one additive required for that purpose. Therefore, if the currently ascertained consistency of the slag is at variance with an optimum consistency, that composition of the possible second compositions which can be produced by introducing additives is selected and striven for which produces the lowest overall costs having regard to the current raw material price in combination with the required quantity of additive(s).

In particular, divalent metal ions are supplied to the foam slag via the at least one additive. For this purpose, the at least one additive can be preferably selected from the group of materials comprising burnt lime, slaked lime, limestone, magnesium oxide, dolomitic lime, iron(II) oxide and the like.

In a further embodiment of the method, the at least one additive is introduced in a quantity such that lime saturation is achieved particularly at the temperature T. This ensures at all times optimum consistency and therefore foamability and reducibility of the slag as well as the required metallurgical work.

In particular, the behavior over time of the formed quantity of foam slag is determined on the basis of the structure-borne noise measurements during refining, wherein carbon and/or oxygen are blown into the electric arc furnace. At this time, all or a large part of the quantity of material to be melted down that is charged into the furnace chamber, particularly scrap, is usually already present in molten form.

In a further embodiment of the method, the optionally determined temperature T of the slag or more specifically foam slag is determined indirectly or directly by a contactless optical temperature measurement using, for example, pyrometers, infrared cameras and the like which record the infrared radiation in the furnace chamber. The temperature T of the slag can be measured directly or the temperature T of the slag floating on the molten bath can be inferred from a measurement of the molten bath temperature.

The determined behavior over time and optionally the temperature T of the slag or more specifically foamed slag can be preferably assigned to a first chemical composition of the slag or more specifically foamed slag by means of a correlation scheme in which behaviors over time determined in previous melting processes, optionally at particular temperatures T, are stored correlated with a respective associated chemical composition of the slag determined by chemical analysis. Such a correlation scheme can be preferably continuously updated and optimized on the basis of the melting processes carried out and the results thereof.

For a foam slag consisting, for example, of a material system (CaO+MgO+MnO)—FeO—(SiO₂+P₂O₅+Al₂O₃), the second chemical compositions are selected at a temperature T of 1650° C. referring to the total weight according to the following three conditions:

### 32-58 wt. % (CaO+MgO+MnO)

### 17-51 wt. % FeO

### 10-30 wt. % (SiO₂+P₂O₅+Al₂O₃).

These compositions define the region II in the material system, in which the slag has an optimum consistency with good foamability and at the same time good reducibility.

If for reasons of cost, for example, the temperature T of the slag is not measured, the respective region for the selection of second chemical compositions is selected smaller. If the temperature of the slag changes, the position of the region of optimum consistency in the material system is shifted and it must be ensured that an appropriate second chemical composition can be selected, regardless of the actual temperature T of the slag.

According to another embodiment, the apparatus for carrying out the method can be achieved in that it comprises
at least one sensor for detecting structure-borne noise on the electric arc furnace,
optionally at least one temperature measuring device for indirectly or directly determining the temperature T of the foam slag,
at least one processing unit which is designed to assign the determined behavior over time and optionally the temperature T of the foam slag to a first chemical composition of the foam slag, to perform a comparison of the first chemical composition with a number of second chemical compositions for the foam slag, and to output at least one open- or closed-loop control signal, and
at least one dosing device, controllable in an open- or closed-loop manner by means of the at least one processing unit, for introducing the at least one additive to the foam slag.

The apparatus enables the furnace to be operated in an efficient and cost-effective manner.

In order to be able to draw upon past experience as to which behavior over time of foam formation is associated with which chemical composition of the slag, in particular a correlation scheme is stored on the at least one processing unit. Stored therein are behaviors over time determined in previous meltdowns, optionally at particular temperatures T, correlated with a respective associated chemical composition of the slag determined by chemical analysis. A database is thereby created which enables a current foam formation behavior over time to be assigned to a foam formation behavior over time previously obtained for different slags, and consequently to the thereto linked chemical composition of the previously analyzed slag.

As already explained in the introduction, FIG. 1 shows as an example of a slag composition the material system (CaO+MgO+MnO)—FeO—(SiO₂+P₂O₅+Al₂O₃) at a typically selected temperature T of 1650° C. Such diagrams will also be familiar to the average person skilled in the art for other material systems from which slags can be composed, and are available for different temperatures. If large amounts of silicon dioxide are present in the slag formed when scrap is melted down, although the slag of this material system is readily and homogeneously foamable and has reduced surface tension and increased viscosity, the reducibility of iron(II) oxide in the slag is greatly diminished and large amounts of iron remain unused in the slag.

The region I in FIG. 1 indicates the chemical compositions of homogeneously foamable, but poorly reducible slags in this material system. The behavior over time of a formed quantity of foam slag produces a curve, wherein the slope thereof can be preferably determined at least in one time interval and assigned to a first chemical composition of the foam slag. With “homogeneously” foamable slags, the slope is minimal, i.e. the amount of foam in the furnace chamber only changes slowly as the amount of carbon added to the slag changes. The magnitude of the slope, which can be positive or negative, directly provides information as to the chemical composition of the slag. In the region of technical lime saturation or more specifically dicalcium silicate saturation (see region II), the slope of the curve is much greater than in the region I when the amount of carbon additive introduced to the slag changes. However, in addition to the slope, other properties of the curve can also be evaluated, such as a dead time in which no change in the slope is detectable, as may occur, for example, after the start of an injection of oxygen into the furnace.

If the slag contains large amounts of iron(II) oxide, the slag has good reducibility. However, the slag is foamable only to a limited extent, has increased surface tension and reduced viscosity. This results in difficulty in blanketing the arc, and consequently high energy losses and problems with furnace operation. The region III indicates chemical compositions of poorly or non-foamable, but readily reducible slags in the slag system.

The chemical composition of the slag is therefore directly related to the slag's consistency which directly affects the foamability thereof. In the slag system as shown in FIG. 1, heterogeneous foaming with at the same time good reducibility is present in slags with chemical compositions in the oval-shaped region II which is known as the region of technical lime saturation or more specifically dicalcium silicate saturation. Here solid lime particles are present in the liquid slag in addition to the carbon dioxide for foam formation. As already explained above, the behavior over time of a formed quantity of foam slag produces a curve, wherein the slope thereof can be preferably determined at least in one time interval and assigned to a first chemical composition of the foam slag. In the case of “heterogeneously” foamable slags, the slope is steeper than with homogeneously foamable slags, i.e. the amount of foam in the furnace chamber changes quickly as the amount of carbon added to the slag changes. The magnitude of the slope, which can be positive or negative, directly provides information as to the chemical composition of the slag.

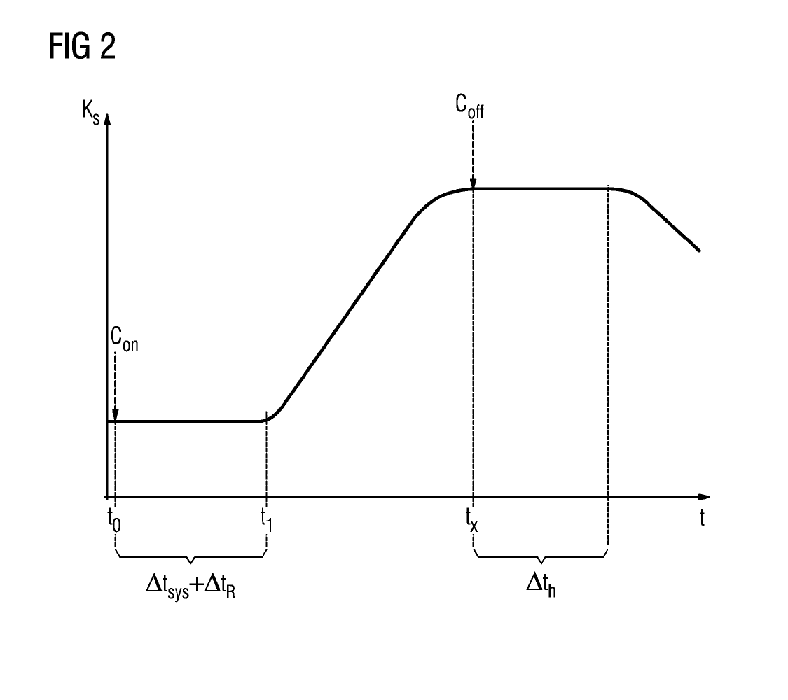

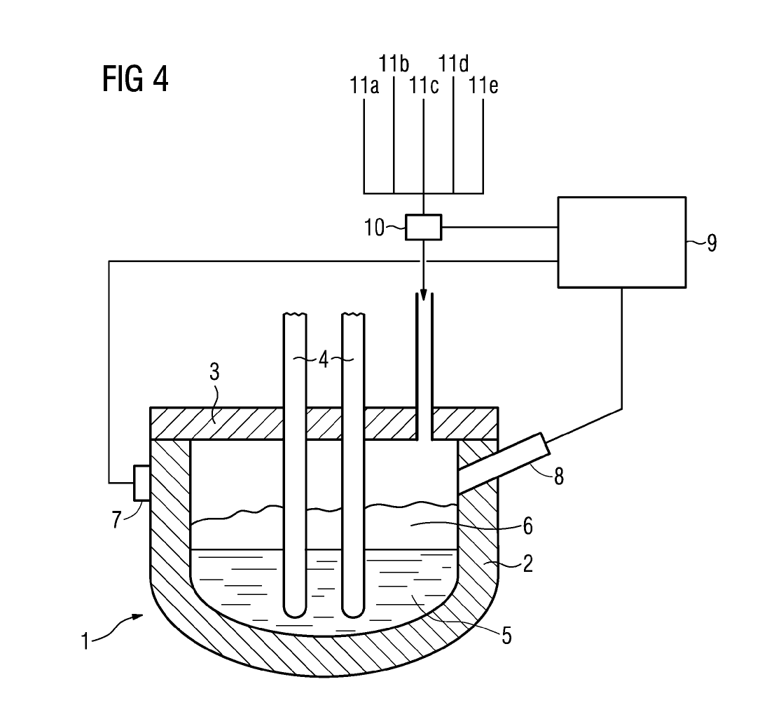

FIG. 2 shows the behavior over time t of a structure-borne noise signal Ks measured on an electric arc furnace 1 (compare also FIG. 4) after the injection of carbon into the furnace vessel 2 during refining of a molten bath 5, wherein the structure-borne noise signal Ks is proportional to a pattern of foam slag development in the furnace vessel 2. The curve or more precisely the structure-borne noise signal curve is evaluated in order to infer the chemical composition of the slag 6.

The injection of carbon Cₒₙ into the furnace vessel 2 commences at a point in time t₀. At a first point in time t₁, a reaction of the slag 6 to the injected carbon is detectable via the structure-borne noise signal Ks, i.e. carbon dioxide is produced and the slag 6 begins to foam. The period until the first point in time t₁ is reached is made up of a system-related dead time Δt_{Sys} in which the carbon is dosed and conveyed into the furnace vessel 2 by a material addition system, and a reaction time Δt_{R} which is required to initiate the reaction of the slag 6 and carbon. The dead time Δt_{Sys} is system-dependent and constant for a particular furnace installation. The reaction time Δt_{R}, on the other hand, is dependent on the type and granularity of the added carbon and on the prevailing conditions in the furnace, in particular the chemical composition of the slag 6 and to a lesser extent the temperature T of the slag 6, the viscosity of the slag 6, the surface tension of the slag 6 and the atmosphere in the furnace vessel 2.

Depending on the chemical composition and therefore the consistency of the slag 6, the latter is more or less strongly foamed. This is indicated by the degree of slope of the structure-borne noise signal curve, a slight slope being equivalent to minimal foam formation and a steep slope to strong foam formation.

At a second point in time tₓ, the supply of carbon C_{off} is terminated. As long as reactive carbon is still present, see time period Δtₕ, the foam slag 6 remains at approximately the level attained. Once the carbon is used up, the foam subsides, as indicated by the fall of the structure-borne noise signal curve.

Various possibilities are now available for inferring the present chemical composition of the slag 6 from the structure-borne noise signal curve. In a further embodiment of the method, the temperature T of the slag 6 during detection of the curve is tracked. This improves the selection of a material phase diagram and therefore the knowledge of the position of the region of lime saturation for the slag 6.

It is possible, for example, to evaluate the reaction time Δt_{R} of the structure-borne noise signal curve, wherein a long reaction time Δt_{R} indicates low reactivity and therefore reducibility of the slag. A long reaction time Δt_{R} therefore suggests an SiO₂-rich chemical composition of the slag 6 in the region I of FIG. 1. From a short reaction time Δt_{R}, on the other hand, high reactivity and therefore reducibility of the slag 6 can be inferred, suggesting a chemical composition of the slag 6 in the region II or III of FIG. 1.

Alternatively or in combination therewith it is possible to evaluate the slope of the structure-borne noise signal curve between the first point in time tᵢ and the second point in time tₓ. A slight slope of the curve in this region indicates low foamability and therefore an Fe-rich chemical composition of the slag 6, while a steep slope of the curve indicates good foamability and therefore suggests a chemical composition of the slag 6 in the region I or II of FIG. 1.

Thus, for example, in the case of a long reaction time Δt_{R} and a steep slope of the curve after the first point in time tᵢ, a particular SiO₂-rich chemical composition of the slag 6 in the region I can be inferred. On the other hand, for example, in the case of a short reaction time Δt_{R} and a slight slope of the curve after the first point in time tᵢ, a particular Fe-rich chemical composition of the slag 6 in the region III can be inferred.

Consequently, determination of the required quantity or type of additive(s) can be specified in order to change this first chemical composition in the direction of a second chemical composition with good foaming and reducing properties in the region II.

However, an evaluation of a time period Δtₕ during which the foam slag 6 remains approximately at the same level, as well as the subsequent fall of the structure-borne noise signal curve can also be evaluated. A long time period Δtₕ in which the foam slag remains at a high level indicates an SiO₂-rich slag.

A slight negative slope of the curve after the period Δtₕ has elapsed again indicates an SiO₂-rich slag.

On the other hand, if the structure-borne noise curve has a steep negative slope after the period Δtₕ has elapsed, this is indicative of a slag with a chemical composition in the region of lime saturation and therefore of the desired composition and consistency.

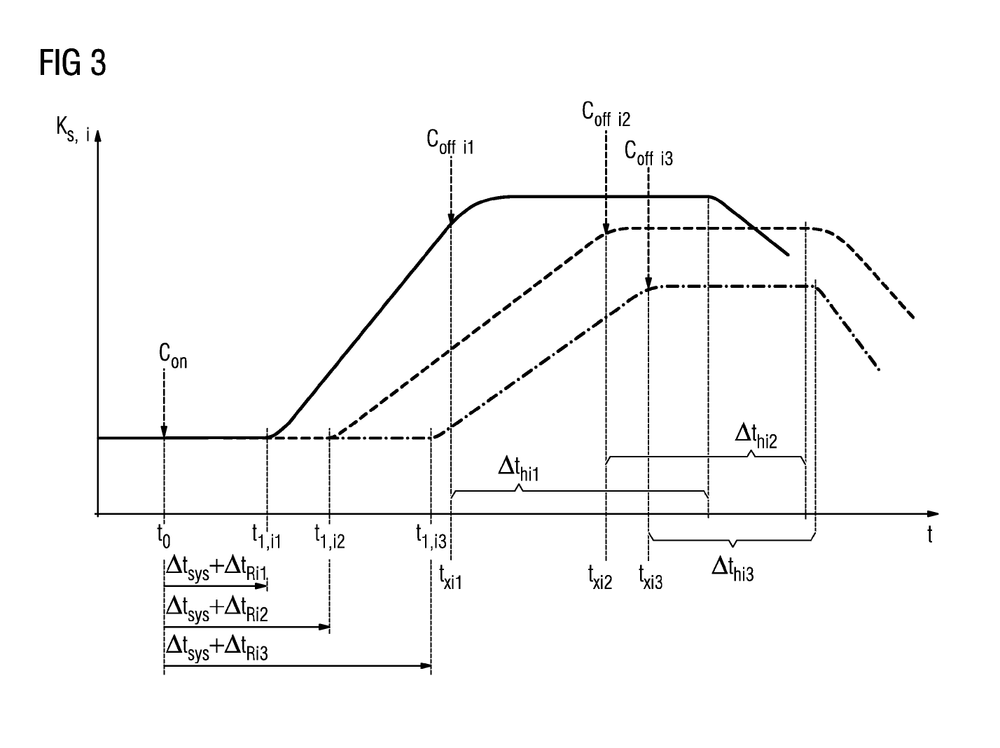

FIG. 3 shows the behavior over time t of structure-borne noise signals Ks,i for i=3 different structure-borne noise sensors 7 on the furnace vessel 2 after the injection of carbon during refining of the slag 6. The diagram is to be read in the same way as that in FIG. 2, wherein the individual parameters of a curve are marked with the respective control variables i1, i2, i3 for the sake of clarity. The three structure-borne noise sensors 7 disposed at different locations on the furnace vessel 2 each produce a curve or more specifically a structure-borne noise signal curve. The more similar the curves for each measurement location, the more uniform the chemical composition of the slag 6 in respect of the molten bath surface in the furnace vessel 2. Differences in the chemical composition of the slag 6 at different locations in the furnace vessel 2 can be detected using different curves. Thus, the chemical composition of the slag 6 can be detected selectively for each measurement location and optimized in respect of foamability and reducibility.

FIG. 4 shows a possible apparatus for carrying out the method. At least one sensor 7 for detecting structure-borne noise is disposed on an electric arc furnace 1 which is here only represented schematically, comprising a furnace vessel 2, furnace roof 3 and electrodes 4. In the furnace vessel 2 are the molten bath 5 with the slag 6 floating on top. Optionally installed is a temperature measuring device 8, in particular for contactless optical temperature measurement, for indirectly or directly determining the temperature T of the slag 6 on the furnace vessel 2. Also present is at least one processing unit 9 which is designed to assign the ascertained behavior over time of the structure-borne noise signal Ks, which is determined by means of the sensor 7, and optionally the temperature T of the foam slag 6, to a first chemical composition of the foam slag 6, to compare the first chemical composition with a number of second chemical compositions for the foam slag 6, and to output at least one open- or closed-loop control signal. The assignment of the ascertained behavior over time, and optionally the temperature T, of the foam slag 6 to a first chemical composition of the foam slag 6 is performed by means of a correlation scheme stored on the processing unit 9, wherein are stored behaviors over time determined in earlier meltdowns, optionally at a temperature T, correlated with the associated chemical composition.

Lastly, there is provided at least one dosing device 10 controllable in an open- or closed-loop manner by means of the at least one processing unit 9 for introducing the at least one additive 11a, 11b, 11c, 11d, 11e to the foam slag 6. If the determination of the first chemical composition of the slag 6 and the comparing of the first chemical composition with a number of second chemical compositions yielding an optimum consistency for the foam slag (compare e.g. FIG. 1, region II) give rise to a discrepancy between the current and the optimum consistency of the foam slag 6, the dosing unit 10 is controlled in an open-loop or closed-loop manner by means of the at least one open- or closed-loop signal generated by the processing unit 9 such that the foam slag 6 is converted from the first chemical composition into one of the second chemical compositions by introducing at least one additive 11a, 11b, 11c, 11d, 11e to the foam slag 6 and an optimized slag consistency with good foamability and at the same time reducibility of the slag 6 is set.

In order to maintain constant the temperature T of the slag 6, which is optionally determined by means of a temperature measuring device 8, closed-loop control of the energy supply to the electrodes 4 by the processing unit 9 can be provided, based on the measured temperature T.

In a further embodiment, the raw material prices of the available additives 11a, 11b, 11c, 11d, 11e are stored on the processing unit 9. The processing unit 9 is in this case designed to select, on the basis of the ascertained first chemical composition of the slag 6 and the raw material prices, a second chemical composition requiring an additional quantity and type of at least one additive which can be achieved with minimum cost.

FIGS. 1 to 4 are merely intended to explain the various embodiments by way of example. Thus the diagram according to FIG. 1 is merely selected as an example of a possible slag composition. When using raw materials usually from the same procurement sources and in the same quantity ratios to produce a molten bath, the average person skilled in the art would know which material system must be used to characterize the molten bath. Previously carried out analyses of slags for various raw material combinations or raw material quantity ratios self-evidently simplify the selection of an appropriate material system.

In general, a plurality of diagrams, optionally for different temperatures T, are stored in the processing unit 9 and can be used to set the optimum slag consistency, optionally also as a function of the temperature T. Also the arrangement and number of structure-borne noise sensor(s), dosing device(s), at least one processing unit and optional temperature measuring device(s), etc. have merely been selected by way of example and can be modified in a simple manner by an average person skilled in the art.

What is claimed is:

1. A method for setting a slag consistency in an electric arc furnace (1), comprising the following steps:
performing structure-borne noise measurements on the electric arc furnace;
determining a behavior over time of a formed quantity of foam slag on the basis of the structure-borne noise measurements;
assigning the determined behavior over time of the foam slag to a first chemical composition of the foam slag that brings about a current consistency of the foam slag;
performing a comparison of the first chemical composition with a number of second chemical compositions for the foam slag that produce an optimum consistency for the foam slag, and,
if the current consistency is at variance with the optimum consistency
converting the foam slag from the first chemical composition into one of the second chemical compositions by introducing at least one additive the foam slag, thereby setting the optimum consistency.

2. The method according to claim 1, wherein the behavior over time of a formed quantity of foam slag produces a curve, the slope of which is determined in at least one time interval and assigned to a first chemical composition of the foam slag.

3. The method according to claim 1, wherein a temperature T of the foam slag present during the structure-borne noise measurements is determined and the determined behavior over time and the temperature T of the foam slag are assigned to a first chemical composition of the foam slag that brings about the current consistency of the foam slag at the temperature T.

4. The method according to claim 3, wherein the first chemical composition is compared with a number of second chemical compositions for the foam slag which produce an optimized consistency for the foam slag at the temperature T.

5. The method according to claim 1, wherein to convert the first chemical composition into one of the second chemical compositions, the quantity of the at least one additive required for that purpose is automatically introduced to the foam slag.

6. The method according to claim 1, wherein the first chemical composition is converted into one of the second chemical compositions which is achievable at the least cost for the at least one additive required for that purpose.

7. The method according to claim 1, wherein divalent metal ions are introduced to the foam slag via the at least one additive.

8. The method according to claim 7, wherein the at least one additive is selected from the group of materials comprising burnt lime, slaked lime, limestone, magnesium oxide, dolomitic lime and iron(II) oxide.

9. The method according to claim 1, wherein the at least one additive is introduced in a quantity producing lime saturation.

10. The method according to claim 1, wherein the behavior over time of the formed quantity of foam slag based on the structure-borne noise measurements is determined during refining during which carbon and/or oxygen are injected into the electric arc furnace.

11. The method according to claim 1, wherein the temperature T of the foam slag is determined indirectly or directly by a contactless optical temperature measurement.

12. The method according to claim 1, wherein the determined behavior over time and possibly the temperature T of the foam slag are assigned to a first chemical composition of the foam slag using a correlation scheme in which variations over time determined in previous melting processes are stored correlated with an associated chemical composition.

13. The method according to claim 1, wherein for a foam slag consisting of a material system —(CaO+MgO+MnO)—FeO—(SiO₂+P₂O₅+Al₂O₃), the second chemical compositions are selected, in particular at a temperature T of 1650° C., referring to the total weight according to the following three conditions:
32-58 wt. %
17-51 wt. % FeO
10-30 wt. % (SiO₂+P₂O₅+Al₂O₃).

14. An apparatus for setting a slag consistency in an electric arc furnace, comprising
at least one sensor for measuring structure-borne noise on the electric arc furnace,
optionally at least one temperature measuring device for indirectly or directly determining the temperature T of the foam slag,
at least one processing unit which is designed to assign the determined behavior over time and optionally the temperature T of the foam slag to a first chemical composition of the foam slag, to compare the first chemical composition with a number of second chemical compositions for the foam slag, and to output at least one open- or closed-loop control signal, and
at least one dosing device controllable in an open- or closed-loop manner by means of the at least one processing unit for introducing at least one additive to the foam slag.

15. The apparatus according to claim 14, wherein the behavior over time of a formed quantity of foam slag produces a curve, and the apparatus is configured to determine a slope of the curve in at least one time interval and to assign the slope to a first chemical composition of the foam slag.

16. The apparatus according to claim 14, wherein the apparatus is further configured to determine a temperature T of the foam slag present during the structure-borne noise measurements and to assign the determined behavior over time and the temperature T of the foam slag to a first chemical composition of the foam slag that brings about the current consistency of the foam slag at the temperature T.

17. The apparatus according to claim 16, wherein the first chemical composition is compared with a number of second chemical compositions for the foam slag which produce an optimized consistency for the foam slag at the temperature T.

18. The apparatus according to claim 14, wherein to convert the first chemical composition into one of the second chemical compositions, the apparatus is configured to introduce the quantity of the at least one additive required for that purpose automatically to the foam slag.

19. The apparatus according to claim 14, wherein the apparatus is further configured to introduce divalent metal ions to the foam slag via the at least one additive.

20. The apparatus according to claim 19, wherein the at least one additive is selected from the group of materials comprising burnt lime, slaked lime, limestone, magnesium oxide, dolomitic lime and iron(II) oxide.
